(19) United States
(12) Patent Application Publication
(10) Pub. No.: US 2005/0124306 A1
(43) Pub. Date: Jun. 9, 2005

(54) Method and apparatus for obtaining and maintaining accurate time

(76) Inventor: Brett Anthony Cheng, Vancouver (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/729,442

(22) Filed: Dec. 5, 2003

(51) Int. Cl. H04B 1/18

(52) U.S. Cl. 455/158.4

(57) ABSTRACT

A method and apparatus for obtaining and maintaining accurate time. A preferred apparatus includes a dedicated timekeeping device, a time synchronization client, and an access point. The timekeeping device is adapted for counting local time. The time synchronization client is adapted to transmit a query signal for querying a time server over a network to cause the time server to provide a current server time. The access point is adapted for producing a wireless signal representative of the current server time for wireless transmission to the timekeeping device, for synchronizing the local time of the dedicated timekeeping device to the current server time.

### FIELD OF INVENTION

The present invention relates to a method and apparatus for obtaining and maintaining accurate time. More particularly, the invention relates to wirelessly synchronizing a dedicated timekeeping device, such as a wristwatch or household clock.

### BACKGROUND OF THE INVENTION

Timekeeping devices such as clocks and watches, including those that are quartz based, eventually drift from the correct time and often require resetting or synchronization with an accurate time source. It is inconvenient for the user to reset the time. Currently, there are radio-synchronized clocks and watches that include a radio receiver tuned to receive a wireless synchronization signal derived from an accurate remote timekeeping source.

For example, an atomic clock is maintained in North America by the National Institute of Standards and Technology (“NIST”). NIST provides a time synchronization signal derived from the clock that is broadcast on a low frequency radio 60 kHz carrier for purposes of synchronizing remote clocks. Existing radio-synchronized timekeeping devices are designed to pick up this signal, and to automatically set their time to the accurate atomic clock.

However, correct synchronization of a watch or clock requires good signal reception of the 60 kHz low-frequency signal, and good reception is not always possible. For example, reception can be hampered by the distance from the transmitter, the weather, the time of the day, the location of the timepiece in the building, obstacles in the reception path, interference reflection, etc., so that some areas cannot reliably receive the NIST signal, thereby preventing synchronization. Moreover, the signal may not be receivable outside continental North America. Also, the time period required to achieve correct synchronization can be undesirably long.

Accordingly, there is a need for a method and apparatus for obtaining and maintaining accurate time, particularly for wirelessly synchronizing a dedicated timekeeping device, which solves the aforementioned problems and meets the aforementioned needs.

### SUMMARY

A preferred apparatus for obtaining and maintaining accurate time according to the present invention includes a dedicated timekeeping device, a time synchronization client, and an access point. The timekeeping device is adapted for counting local time. The time synchronization client is adapted to transmit a query signal for querying a time server over a network to cause the time server to provide a current server time. The access point is adapted for producing a wireless signal representative of the current server time for wireless transmission to the timekeeping device, for synchronizing the local time of the dedicated timekeeping device to the current server time.

A preferred method for obtaining and maintaining accurate time according to the present invention includes querying a time server over a network to cause the time server to provide a current server time. The method further includes producing a wireless signal representative of the current server time. The method further includes transmitting the wireless signal to a dedicated timekeeping device adapted to count local time. The method still further includes synchronizing the local time of the dedicated timekeeping device to the current server time by use of the wireless signal.

### BRIEF DESCRIPTION OF THE DRAWINGS

FIG. 1 shows an exemplary apparatus for obtaining and maintaining accurate time according to the present invention.

FIG. 2 shows a block diagram of a preferred embodiment of a dedicated timekeeping device portion of the apparatus of FIG. 1 according to the present invention.

### DETAILED DESCRIPTION

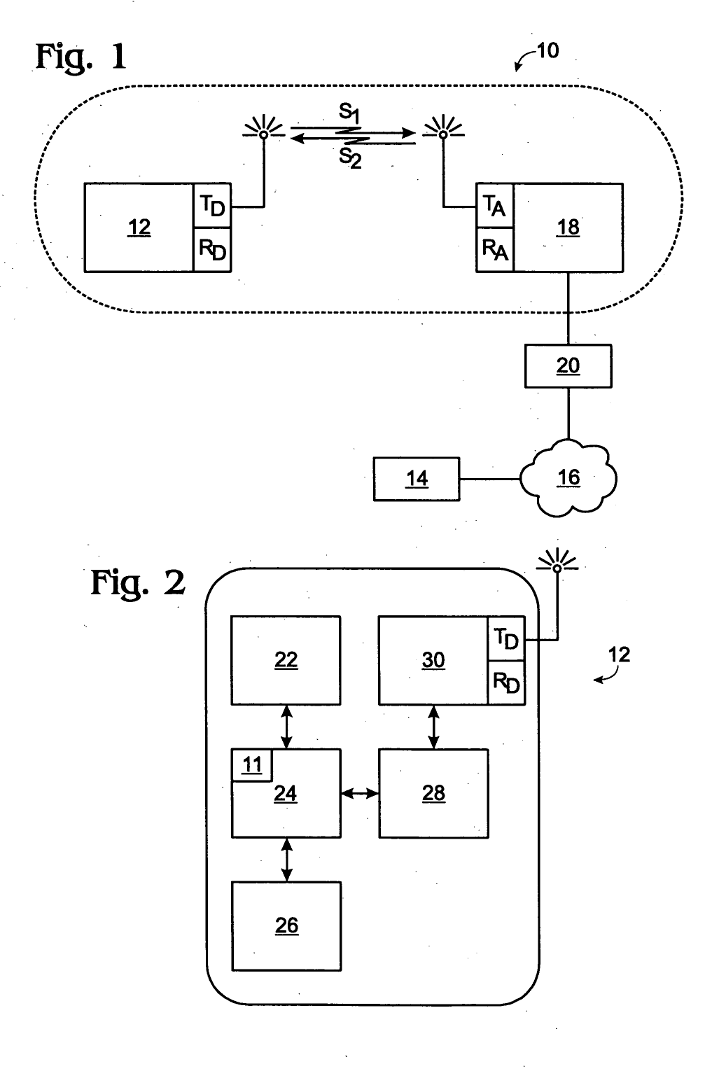

Referring to FIG. 1, an exemplary apparatus 10 for obtaining and maintaining accurate time according to the present invention is shown. The system 10 includes a timekeeping device 12 that keeps and displays time. The timekeeping device 12 establishes a wireless connection to a time server 14, which provides accurate time information for resetting or synchronizing the timekeeping device.

It should be understood throughout that the features described may be implemented by any standard means in software, hardware, or combination thereof. In the description to follow, a controller 11 (FIG. 2) will be assumed for carrying out control functions in addition to the specific functions described. The controller 11 is preferably a processor that executes programs of instruction as described below, though it will be understood that any equivalent structure or structures could be used.

The time server 14 obtains time information from a highly accurate time source, preferably, the atomic clock maintained by NIST. However, the time source may be any desired source of time information. The time server 14 is connected to a network 16 and transmits the time information over the network. In the preferred embodiment, the network is the Internet, and the time server is the NIST Internet Time Service (“ITS”). Updated time information can also be obtained from servers that are maintained by other timekeeping organizations without departing from the principles of the invention.

The time information can be accessed from the ITS time server using various formats including the DAYTIME, TIME and NTP protocols. Alternatively, the time information can also be downloaded from the ITS web site which is located on the Internet.

When queried, the time server 14 transmits time information over the network 16 to an access point 18 for access to the network 16 by the timekeeping device 12. The access point 18 is connected to the network by a network access device 20, which is coupled to the network. The network access device 20 can be a modem, an asymmetrical digital subscriber line (“ADSL”), or any other desired means for interconnecting the access point to the network without departing from the principles of the invention.

An outstanding advantage of the system 10 is that the access point 18 provides a wireless interconnection between the device 12 and the time server 14. The access point 18 has a transmitter/receiver pair T_{A}/R_{A} for wirelessly communicating with the timekeeping device 12. The timekeeping device has a corresponding transmitter/receiver pair T_{D}/R_{D} for wirelessly communicating with the access point 18. In particular, a time query signal S₁ is sent by the transmitter T_{D} of the timekeeping device to the receiver R_{A} of the access point 18. Reciprocally, the time information obtained from the time server 14 is sent as a signal S₂ from the transmitter T_{A} of the access point to the receiver R_{D} of the timekeeping device 12. The signals S₁ and S₂ can be encoded with a digital signal, which can be decoded by the receivers Alternatively, the signals S₁ and S₂ can be modulated with analog signals which are converted to digital signals by the receivers. The signals can be transmitted as infrared signals, radio signals, or other types of signal modalities without departing from the principles of the invention.

The access point converts the signal S₁ to a “time query signal” appropriate for transmission by the network access device 20, which subsequently transmits the time query signal over the network 16 to the time server 14. For example, where the network access device is a wired device, the access point converts the signal S₁ from a wireless form to a time query signal form adapted to propagate over a wire.

The access point 18 may provide for short-range wireless communications with the timekeeping device 12 such as Wi-Fi/802.11b or Bluetooth, or long-range wireless communications such as WMAN 802.16a. The access point may be either a general purpose access point such as a standard WiFi access point for use with a wireless PC, or a dedicated access point specifically for the purpose of communicating with the timekeeping device 12. When providing for long-range communications, the access point may be located a long distance away from the timekeeping device 12, such as outside, on a telephone pole or on top of a building.

The time server answers the query represented by the signal S₁ by providing updated time information and transmits the updated information as a “time information signal” over the network 16, through the network access device 20, to the access point 18. The access point 18 converts the time information signal to the wireless reply signal S₂ and the transmitter T_{A} transmits the signal S₂ to the timekeeping device 12, where the reply signal S₂ is received by the receiver R_{D}. Time information can include the time of day, date and day of the week or other information relating to the time or the calendar.

As shown in FIG. 2, the timekeeping device 12 includes a clock 22, which keeps or “counts” local time, and a display which displays the kept local time to a user. Like the time information, the time kept by the timekeeping device 12 includes the time of day, date and day of the week or other information relating to the time or the calendar. The term “local time” is intended herein to refer to the time kept locally, i.e., by the clock 22, which typically is the time appropriate for the area in which the timekeeping device is located, but which may in the alternative or in addition include the time for other time zones.

For setting, resetting or more generally synchronizing the system 10 includes a time synchronization client 24, a configuration settings file 26, a protocol converter 28 and a client hardware device 30. The time synchronization client 24 includes a software application program, hardware, or combination of hardware and software as desired, having the capability of requesting updated time information from the time server 14. A network address of the time server is stored in the configuration settings file 26. In the preferred embodiment, the configuration settings file stores the IP address of a time server 14 that is located on the Internet. Preferably, the IP address of the time server 14 is preprogrammed into the configuration settings file 26. The configuration settings file also stores time information such as time zone and whether it is day-light savings time. Additional information can be stored in the configuration settings file 26 without departing from the principles of the invention.

The time synchronization client 24 obtains the IP address of the time server 14 from the configuration settings file 26 so that the time synchronization client can query the time server 14. In the preferred embodiment, the request by the time synchronization client is sent to the time server 14 using the Transmission Control Protocol/Internet Protocol (“TCP/IP protocol”), which is the protocol used by the Internet. However, other protocols can be used without departing from the principles without departing from the principles of the invention. Because the time synchronization client does not itself format requests according to the TCP/IP format, the time synchronization client 24 passes its request to the protocol converter 28. The protocol converter includes a software application program, hardware, or a combination of hardware and software as desired, that translates the request into the TCP/IP format. The protocol converter also converts responses received from the time server from the TCP/IP format into a format understood by the time synchronization client.

The protocol converter 28 interfaces directly with the client hardware device 30. As will be appreciated by one skilled in the art, the client hardware device typically includes a chip set including an analog-to-digital converter, a digital-to-analog converter, a transceiver, and logic necessary to enable communication according to a wireless protocol.

The client hardware device 30 provides for wireless communication with the access point 18. Particularly, the device 30 includes the transmitter/receiver pair T_{D}/R_{D}, for transmitting the signal S₁ and receiving the signal S₂. Preferably, the client hardware device 30 conforms to a wireless local area network (“WLAN”) standard such as Wi-Fi/802.11b or 802.11g. However, other standards may be used such as Bluetooth and wireless metropolitan area network (“WMAN”) if desired.

The timekeeping device 12 is dedicated to receive and display time information, and not other types of information. Preferred examples of such dedicated timekeeping devices are wrist watches and house-hold clocks. Preferably, the aforementioned time synchronization client 24, configuration settings file 26, protocol converter 28, and client hardware device 30 are provided integrally with the timekeeping device 12; however, one or all of the synchronization client 24, settings file 26, converter 28, and the transmitter portion T_{D} of the client hardware device 30 may be provided outside of the timekeeping device, such as at the access point 18.

The clock 22 can be battery operated, can plug into an electrical outlet, or can be powered in other ways without departing from the principles of the invention. The time display can be an analog dial, a digital display, any other kind of graphical display, a bit-mapped computer-style display or any other kind of display. The clock can be free standing, can attach to a wrist or other item, be built into another device, or attached to the wall, etc. without departing from the principles of the invention.

Returning to FIG. 1, when the timekeeping device 12 decides to update the time, it transmits a wireless request via the access point 18 to the time server 14. The time synchronization client 24 formulates the request and can be programmed to request time information every time a predetermined amount of time has passed. For example, the time synchronization client can be preprogrammed to request time information from the time server 14 every four hours, or once every week. Alternatively, the time keeping device 12 does not have to be preprogrammed and the times or time intervals for updating the time can be set by the user. The time synchronization client 24 receives the information regarding the IP address of the server from the configuration settings file 26. The request is forwarded to the protocol converter 28 and formatted into the TCP/IP protocol. Next, the request is sent to the client hardware device 30, where the request is wirelessly transmitted by the transmitter T_{D} to the access point 18. As indicated above, the access point's receiver R_{A} receives the request and the access point's transmitter T_{A} transmits the request to the network access device 20.

The system 10 next awaits a reply to its request for updated time. If the system 10 receives a reply within a predetermined time, the system 10 updates the system time to that provided by the time server. For most practical purposes, it is of no concern that there is some delay in the time between sending the request and receiving an update for the time, because the delay is not very great. However, as will be appreciated by persons of ordinary skill, it is possible to account for the delay to varying degrees of precision if necessary.

On the other hand, if the system 10 does not receive a reply from the time server within a predetermined period, the system 10 preferably refrains from updating the time. In addition, the system 10 may provide for one or more repeated re-tries spaced by predetermined periods.

The time information received from the time server may need to be adjusted to provide a time appropriate for the local time zone in which the timekeeping device 12 is located. It should be understood that this is not essential; for example, it may be advantageous to require the user to set the hour and date while using the time server only to update the minutes and seconds, since these are most susceptible to drift. However, in most instances, adjusting the time information for the local time is desirable. This requires obtaining both the local time zone and the server time zone, i.e., the time zone for which the time information provided by the time server has been calibrated. For example, if the time server is set to provide time in Mountain Time, and the local time zone is Pacific Time, the time information may be adjusted to account for the 1 hour difference between Mountain Time and Pacific Time. A number of different strategies may be employed for providing the two time zones.

One such strategy is to preprogram both time zones. According to this strategy, the timekeeping device would seek time information from a preprogrammed time server calibrated to a known time zone, and the timekeeping device would be used within a preprogrammed local time zone.

Another strategy is to provide either or both time zones as a preprogrammed list of options from which the user may choose. The timekeeping device may include input devices such as a touch menu, dedicated buttons, switches, voice recognition software, etc., permitting the user to choose a desired set of preprogrammed options.

Yet another strategy is to permit the user to enter either or both time zones directly using the same types of input devices. The aforementioned input devices may communicate with the processor 11, which in turn may save input information such as time zone and standard/daylight savings indicators in the configuration settings file 26. The processor 11 may also perform the time zone conversions. It may also be possible for the time server to perform a time zone calibration given the local time zone as a query input, in which case the time zone of the server need not be taken into account.

At any time when the system 10 is not requesting and receiving time synchronization data, at least the time synchronization client 24, configuration settings file 26, the protocol converter 28, and the client hardware device 30 can be powered down at the direction of the processor 11. This feature is especially advantageous in a battery powered embodiment of the system 10, such as a wristwatch, and is even more advantageous where updates are requested only infrequently. Preferably, the number of times the system 10 re-tries a failed request as mentioned above is balanced against the need to conserve power in battery-powered implementations.

The terms and expressions that have been employed in the foregoing specification are used as terms of description and not of limitation, and are not intended to exclude equivalents of the features shown and described or portions of them. The scope of the invention is defined and limited only by the claims that follow.

1. An apparatus for obtaining and maintaining accurate local time, comprising:
a dedicated timekeeping device for counting local time;
a time synchronization client adapted to transmit a query signal for querying a time server over a network to cause the time server to provide a current server time; and
an access point for producing a wireless signal representative of said current server time for wireless transmission to said timekeeping device, for synchronizing the local time of said dedicated timekeeping device to said current server time.

2. The apparatus of claim 1, wherein said timekeeping device includes a display for displaying the synchronized local time.

3. The apparatus of claim 2, wherein said time synchronization client is disposed in said access point.

4. The apparatus of claim 3, wherein said network includes the Internet.

5. The apparatus of claim 2, wherein said time synchronization client is disposed in said timekeeping device.

6. The apparatus of claim 5, said timekeeping device further including a transmitter for wirelessly transmitting said query signal to said access point.

7. The apparatus of claim 6, wherein said network includes the Internet.

8. The apparatus of claim 5, further comprising a controller adapted to power down said time synchronization client at least some of the time during which said time synchronization client is not transmitting said query signal.

9. The apparatus of claim 8, wherein said network includes the Internet.

10. The apparatus of claim 5, wherein said timekeeping device includes a memory for storing time zone information and a controller for adjusting the local time based on said time zone information.

11. The apparatus of claim 10, wherein said network includes the Internet.

12. The apparatus of claim 10, further comprising a controller adapted to power down said time synchronization client at least some of the time during which said time synchronization client is not transmitting said query signal.

13. The apparatus of claim 12, wherein said network includes the Internet.

14. A method for obtaining and maintaining accurate local time, comprising:
querying a time server over a network to cause the time server to provide a current server time;
producing a wireless signal representative of said current server time;
transmitting said wireless signal to a dedicated timekeeping device adapted to count local time; and
synchronizing the local time of said dedicated timekeeping device to said current server time by use of said wireless signal.

15. The method of claim 14, further comprising wearing said dedicated timekeeping device on a part of the body.

16. The method of claim 15, further comprising powering down at least a portion of said timekeeping device at least some of the time during which said time server is not being queried.

17. The method of claim 16, wherein said network includes the Internet.

18. The method of claim 14, further comprising powering down at least a portion of said timekeeping device at least some of the time during which said time server is not being queried.

19. The method of claim 14, wherein said network includes the Internet.

20. The method of claim 14, wherein said step of querying includes wirelessly transmitting a query signal.
